(19) United States
(12) Patent Application Publication
(10) Pub. No.: US 2025/0033265 A1
(43) Pub. Date: Jan. 30, 2025

(54) METHOD FOR PRODUCING A FILM HAVING A SECURITY FEATURE FOR A CARD-SHAPED DATA CARRIER, FILM AND CARD-SHAPED DATA CARRIER

(71) Applicant: Giesecke+Devrient ePayments GmbH, Munich (DE)

(72) Inventors: Josef RIEDL, Attenkirchen (DE); Peter TARANTINO, Munich (DE)

(21) Appl. No.: 18/776,801

(22) Filed: Jul. 18, 2024

(30) Foreign Application Priority Data
Jul. 28, 2023 (DE) 102023120169.7

(51) Int. Cl. B29C 48/285; B29C 48/00; B29C 48/08; B29C 48/88; B29K 67/00; B29K 69/00; B29K 75/00; B29K 105/00; B29K 105/26; B29L 17/00

(52) U.S. Cl. CPC B29C 48/297; B29C 48/0014; B29C 48/08; B29C 48/914; B29K 2067/003; B29K 2067/046; B29K 2069/00; B29K 2075/00; B29K 2105/0032; B29K 2105/26; B29K 2995/0097; B29L 2017/00

(57) ABSTRACT

A method for producing a film having a security feature for a card-shaped data carrier includes: providing at least one film material having a base color; providing at least one coloring agent; introducing the film material into an extruder of an extrusion apparatus; heating the film material to form a melt; separately heating the coloring agent to form a flowable color; extruding the melt through a nozzle outlet gap of the extrusion apparatus; feeding the flowable color to the extruded melt to form a bead-like mixture; mixing of the flowable color and the extruded melt within the bead-like mixture to form a film. The extruded melt and the flowable color have different material properties so that they do not mix homogeneously, whereby a randomized multi-coloring is visible in plan view of the film. A film and a card-shaped data carrier are associated with aspects of the method.

### BACKGROUND

The invention relates to a method for producing a film having a security feature for a card-shaped data carrier, a film having a security feature for a card-shaped data carrier and a card-shaped data carrier having a film.

A large number of card-shaped data carriers are known from the prior art, for example smart cards, chip cards, in particular with RFID technology (Radio Frequency Identification), integrated circuit cards, dual interface cards, health cards, transit cards or identification cards. In particular, the use of smart cards, such as credit cards or payment cards, has become established for carrying out financial transactions. Card-shaped data carriers such as security documents, for example passport and ID documents, ID cards and the like are increasingly being used in public areas, but also in the in-house sector.

The card-shaped data carrier typically has a card body having a module opening to accommodate a chip module or other electronic components for contact-based and/or contactless data communication. It is often the case that the card body is formed from multiple films, wherein the individual films are bonded together by means of lamination using pressure and heat to form a film layer composite. Design films or transparent cover films, so-called overlay films, having security features are preferably provided on the surface of the card body. Optical security features on the card-shaped data carriers are known and are generally intended to increase counterfeit protection.

It is also known that homogeneous single-color films in particular are used for lamination to form a film layer composite. It is true that the use of multiple films having different colors can achieve a certain degree of multi-coloring of the card-shaped data carrier in the volume. However, this is typically homogeneous and has a fixed pattern. However, in order to increase the counterfeit protection of the card-shaped data carrier, it is desirable to provide a randomized multicoloring for the card-shaped data carrier.

### SUMMARY

The object of the present invention is therefore to provide the production of films having security features for card-shaped data carriers having improved multi-color capability.

This object is achieved by a method for producing a film having a security feature for a card-shaped data carrier, a film having a security feature and by a card-shaped data carrier according to the independent claims. Embodiments and developments of the invention are disclosed in the dependent claims. Features and details described in connection with the method according to the invention for producing a film having a security feature for a card-shaped data carrier also apply in connection with the film according to the invention having a security feature and the card-shaped data carrier, and vice versa in each case, so that mutual reference can always be made to the individual aspects of the invention with regard to the disclosure.

Within the scope of the application, the invention can preferably be used for smart cards, in particular for credit cards and payment cards, ID documents or identification cards, health cards or transit cards. However, use may also be envisaged for other RFID devices, such as for example key cards, access cards, tokens, wearables or security badges.

According to one aspect of the invention, a method for producing a film having a security feature for a card-shaped data carrier is provided, which comprises the following steps:
providing at least one film material having a base color;
providing at least one coloring agent;
introducing the film material into an extruder of an extrusion apparatus;
heating the film material to form a melt;
separately heating the coloring agent to form a flowable color;
extruding the melt through a nozzle outlet gap of the extrusion apparatus;
feeding the flowable color to the extruded melt to form a bead-like mixture;
mixing of the flowable color and the extruded melt within the bead-like mixture to form a film, wherein the extruded melt and the flowable color have different material properties so that they do not mix homogeneously, whereby a randomized multi-coloring is visible in plan view of the film.

Within the scope of the application, for example, the film material can be provided as granulate for the extruder, in particular as plastic granulate or polymer granulate. The film material has a base color, which is preferably monochrome and homogeneous. In particular, the coloring agent can be provided in powder form. Preferably, multiple coloring agents can also be provided.

The film material is introduced or filled into the extruder and heated or melted to form a melt. In other words, the film material is converted into a meltable state. Separately from heating the film material, the coloring agent is heated or melted to form a flowable color. In other words, the coloring agent is heated separately from the film material. The melt can then be extruded or pressed out through the nozzle outlet gap. The nozzle outlet gap represents a shape-forming opening. Preferably, the flowable color is fed to the extruded melt, in particular adjacent to the nozzle outlet gap. By feeding the flowable color to the extruded melt, a bead-like mixture can be formed. Within the bead-like mixture, the flowable color and the extruded melt can mix and form a film. Due to the different material properties, homogeneous mixing does not take place. Preferably, inhomogeneous randomized mixing takes place. This means that a randomized multicoloring is visible when the formed film is viewed from above. In particular, the randomized multicoloring of the film represents the safety feature. The bead-like mixture can usually cool down or solidify completely within a specific time interval after emerging from the nozzle outlet gap due to cooling.

The randomized or randomly distributed multicoloring occurs in particular because the flowable color and the extruded melt mix inhomogeneously, i.e. randomly distributed, in the bead-like mixture. This allows the base color and the color of the coloring agent to mix and create the multicoloring. In other words, a multi-colored marbling of the film is achieved. For example, a red coloring agent and a film material having a white base color can be provided. A red-white or mixed marbling is then produced within the bead-like mixture. In principle, any color can be selected within the scope of the application.

It is also conceivable within the scope of the application that a co-extrusion is used for the film to be formed. For example, a first film material and a second film material can be provided. The first film material can be introduced into a main extruder of the extrusion apparatus. The second film material can be introduced into a secondary extruder of the extrusion apparatus. The film materials can be heated to form a first melt and to form a second melt. The first melt and the second melt can then be co-extruded through the nozzle outlet gap of the extrusion apparatus, whereby a multilayer film can be formed overall, wherein the multilayer film also has a randomized multicoloring due to the supply of the flowable ink.

In general, multiple different materials can be conveyed through the same extrusion apparatus during co-extrusion, in particular also three or four or more materials. Furthermore, it is conceivable that multiple materials are generally provided for the main extruder and multiple materials for the secondary extruder.

The sequence of the steps of the method according to the invention is not necessarily limited to the sequence described or fixed in time.

The invention has the advantage that the randomized or randomly distributed multicoloring represents an individual security feature for each individual card-shaped data carrier, which can be permanently integrated into the film, thereby significantly increasing the counterfeit protection of a card-shaped data carrier having such a security feature. In particular, translucent, opaque, randomly distributed colored films can be produced which have different color shades in volume and/or surface area. The multicoloring can be easily recognized by a user of the card-shaped data carrier. The multicoloring also has the advantage that it cannot be easily reproduced by making a photocopy of the card-shaped data carrier or by scanning and printing, even if the copy or print is of the highest quality. Consequently, unlawful reproduction of the card-shaped data carrier can be prevented and the authenticity of the card-shaped data carrier can be guaranteed by means of the security feature.

Advantageously, the method according to the invention can also be used with commercially available extrusion apparatuses and is thus simple to implement.

In a particularly preferred embodiment, it may be provided that the method also comprises the following step:
cooling of the film at a roller arrangement adjacent to the nozzle outlet gap, comprising at least one cooling roller.

Within the scope of the application, the roller arrangement can preferably comprise multiple rollers, which can be coupled or arranged next to one another. In particular, one or more cooling rollers, conveying rollers or winding rollers may be provided. The number of rollers of the roller arrangement can be specifically adapted to the film production, in particular to the cooling process of the film. Preferably, the roller arrangement is arranged immediately adjacent or directly adjacent to the nozzle outlet gap.

Alternatively or additionally, it may be provided that the roller arrangement comprises at least two cooling rollers, wherein the bead-like mixture is conveyed between the cooling rollers. In particular, the cooling rollers are arranged opposite each other so that the bead-like mixture is conveyed between the cooling rollers after it emerges from the nozzle outlet gap. In particular, the bead-like mixture can be conveyed in a gap between the cooling rollers. This advantageously ensures mixing of the flowable color and the extruded melt within the bead-like mixture. The distance between the cooling rollers or the gap size between the cooling rollers can be adapted in particular to the thickness of the film to be formed.

Preferably, it can be provided that a differential speed of the cooling rollers is set and/or the cooling rollers are operated alternately at different speeds. Advantageously, this allows the bead formation between the cooling rollers to be specified even more precisely and adapted to the properties of the film to be produced. In particular, the throughput can also be adjusted to determine the quantity of the bead-like mixture that is conveyed through the cooling rollers. For example, the marbling of the film can also be influenced and adapted.

It is particularly preferable for the film material to have a transparent or opaque base color. For example, the film material is a plastic material or a polymer material. In other words, the polymer material is a type of carrier material for the multicoloring. For example, various polymers such as polycarbonate (PC), polylactic acid (PLA), polyethylene, polyester or polyethylene terephthalate (PET) can be used. Preferably, the polymer material is formed from a recycled material, e.g. so-called ocean plastic, which is based on marine plastic waste. For example, it may be provided that the film material is formed with a transparent base color and a flowable red color is added. This is an example of a simple form of marbling. If a film material having an opaque base color, such as a white base color, is used, a more complex multicoloring and marbling can even be achieved by mixing it with a flowable red color. The complexity of the multicoloring and marbling can be adjusted and adapted depending on the use of the base color of the film material and the coloring agents for the flowable colors.

Alternatively or additionally, it may be provided that the flowable color is thermostable and/or has a high viscosity. Advantageously, the flowable color has thermal stability. This ensures that the color is not destroyed when it is heated or transferred to the flowable state.

It may be particularly preferable for the flowable color to be formed by an offset color or a radiation-crosslinking color, in particular a UV ink. Other flowable colors are generally conceivable.

Preferably, it can be provided that the flowable color is fed to the extruded melt by means of a separate nozzle or by means of a nozzle of the extrusion apparatus. In the embodiment of the nozzle of the extrusion apparatus, the nozzle can preferably be arranged neighboring or directly adjacent to the extruder and the nozzle outlet gap of the extrusion apparatus. This ensures that the flowable color and the extruded melt can be brought together as quickly as possible and thus effectively in order to form the bead-like mixture. The embodiment of the separate nozzle has the advantage that particularly simple separate heating of the coloring agent to form a flowable color can be achieved. However, it is also preferable for the separate nozzle to be arranged neighboring or directly adjacent to the extruder and the nozzle outlet gap of the extrusion apparatus.

Preferably, the nozzle can be heated. This makes it particularly easy to heat the coloring agent to form a flowable color.

Advantageously, it may be provided that the nozzle has at least one chamber for the flowable color. In particular, the chamber represents a receiving unit for providing the coloring agent. In other words, the coloring agent can be introduced or filled into the chamber of the nozzle. The coloring agent can then be heated within the chamber of the nozzle so that a flowable color can be formed. For example, the nozzle itself can be heated or an external heat supply can be used for this purpose. The flowable color can then be pressed out of the chamber through a narrow opening in the nozzle and fed to the extruded melt. In this way, the flowable color can preferably be dosed.

In particular, the nozzle may have multiple chambers, especially a multi-chamber system, wherein a different flowable color is provided for each chamber. The multiple chambers render it possible for a complex multicoloring to be formed to be already provided by using multiple coloring agents. The different coloring agents can be divided particularly easily using the multiple chambers and yet heated simultaneously in order to provide the different flowable colors. This enables efficient dosing and feeding of the different flowable colors. For example, three chambers can be provided in the nozzle, wherein a red coloring agent is introduced or filled into the first chamber, a green coloring agent into the second chamber and a blue coloring agent into the third chamber. Due to the heating of the nozzle, the respective coloring agent in the chamber can be heated simultaneously and a red, green and blue flowable color can be produced in the respective chambers. The flowable colors can then be pressed out through a respective narrow opening of the nozzle and fed to the extruded melt. In other words, an associated narrow opening is provided for each chamber, wherein the respective flowable color can emerge from the nozzle.

It is particularly preferable for the chambers to be arranged mounted one after the other within the nozzle, whereby the different flowable colors can be fed in strips. In other words, the chambers within the nozzle are preferably arranged adjacent to each other or next to each other. This allows the flowable colors to emerge from the nozzle in strips. This enables particularly simple and targeted feeding of the flowable colors to the extruded melt.

Advantageously, it can be provided that the different flowable colors each have different material properties. This prevents the colors from mixing homogencously to form a brown-black mixture. In particular, the desired inhomogeneous mixing and thus the randomized multicoloring can be achieved due to the different material properties. For example, the different flowable colors can differ in terms of the melting temperature and/or melt viscosity parameters. Colors with a high melt viscosity are preferably used.

According to a second aspect of the invention, there is provided a film having a security feature for a card-shaped data carrier which is produced by the method according to one of the preceding embodiments. The same advantages and modifications as described above apply.

Particularly preferably, it may be provided that the film has a thickness of 25-100 μm, preferably 50-100 μm. For example, the film having the security feature can be laminated or bonded into a film layer composite. Particularly preferably, the film produced having a security feature can be used as an overlay film for a card-shaped data carrier.

According to a third aspect of the invention, a card-shaped data carrier, in particular a smart card, is provided, comprising a card body on which a film having a security feature according to one of the preceding embodiments is arranged. The same above described advantages and modifications apply.

### BRIEF DESCRIPTION OF THE DRAWINGS

The present invention is described below with reference to the accompanying figures by way of example in the context of embodiments. Of course, individual features of the embodiments can be freely combined with one another, provided this is technically expedient, without departing from the scope of the present invention. Elements with the same function and mode of operation are labeled with the same reference symbols in the figures. The figures below show schematically:

FIG. 1: a method for producing a film having a security feature for a card-shaped data carrier according to an exemplary embodiment of the invention, and

FIG. 2 a card-shaped data carrier according to an exemplary embodiment according to the invention, which is produced according to the method of FIG. 1.

### DETAILED DESCRIPTION OF THE INVENTION

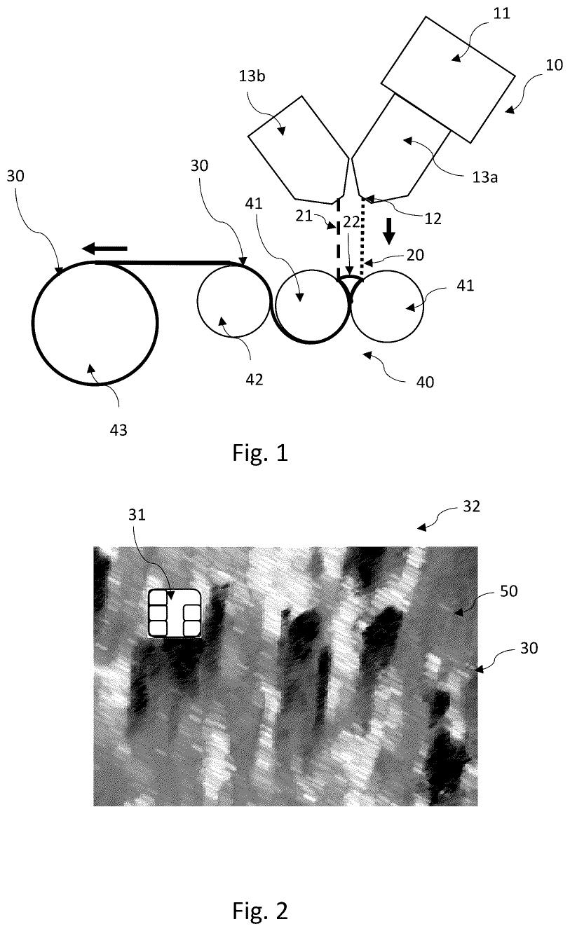

FIG. 1 shows a method for producing a film 30 having a security feature for a card-shaped data carrier according to an exemplary embodiment according to the invention.

An extrusion apparatus 10 is provided for producing the film. The extrusion apparatus 10 has, by way of example, an extruder 11, a first nozzle 13a, a second nozzle 13b and a nozzle outlet gap 12. First, a film material having a white base color, not shown, is provided. The film material can be a plastic granulate, for example. The film material is introduced or filled into the extruder 11.

The film material is then heated or melted to form a melt 20. For example, the film material is heated in the extruder 11 and extruded or pressed out via the first nozzle 13a or the nozzle outlet gap 12. The extruded melt 20 is illustrated in the figure by the dashed line as a mass flow. The extruded melt 20 is then conveyed to the nozzle outlet gap 12, for example along the direction of the arrow.

Furthermore, a coloring agent with a red color, not shown, is provided. The coloring agent can, for example, be in powder form. In particular, it is intended that the coloring agent is heated separately in order to form a red flowable color 21. The second nozzle 13b is provided for this purpose, wherein the coloring agent can be introduced or filled into the second nozzle 13b. For this purpose, the second nozzle 13b has by way of example a chamber, not shown. In particular, the chamber represents a receiving unit for providing the coloring agent. In other words, the coloring agent can be introduced or filled into the chamber of the nozzle 13b. The coloring agent can then be heated within the chamber of the nozzle 13b so that a flowable color 21 can be formed. For this purpose, the second nozzle 13b is heated to provide the necessary heat supply. The flowable color 21 can then be pressed out of the chamber through a narrow opening in the nozzle 13b in order then to be fed to the extruded melt 20. As an example, the first nozzle 13a and the second nozzle 13b are arranged neighboring or directly adjacent to each other. The flowable color 21, which emerges from the second nozzle 13b, is illustratively shown in the figure by the further dashed line as a mass flow. As an example, it is provided here that the flowable color 21 and the extruded melt 20 are conveyed parallel to each other in the direction of the arrow after emerging from the nozzles 13 a, b.

It is further provided that the flowable color 21 is fed to the extruded melt 20 to form a bead-like mixture 22. For this purpose, by way of example a roller arrangement 40 is provided, which comprises multiple, in particular four, rollers 41, 42, 43, which are coupled or arranged next to each other. By way of example, two cooling rollers 41, a winding roller 43 and a conveying roller 42 are provided. The number of rollers 41, 42, 43 of the roller arrangement 40 can be specifically adapted to the film production, in particular to the cooling process of the extruded melt 20.

The two cooling rollers 41 are arranged directly adjacent to each other. One cooling roller 41 is provided on the right-hand side and one on the left-hand side. Furthermore, the two cooling rollers 41 are arranged adjacent to the nozzles 13 a, b or to the nozzle outlet gap 12. As an example, the extruded melt 20 thus impinges on the right-hand cooling roller 41. The flowable color 21 impinges on the left-hand cooling roller 41. The cooling rollers 41 are mounted to rotate and thus the flowable color 21 can be fed to the extruded melt 20 through the rotation process. When the flowable color 21 meets the extruded melt 20, the bead-like mixture 22 is formed. The bead-like mixture 22 is illustratively formed between the two cooling rollers 41. The flowable color 21 and the extruded melt 20 are mixed within the bead-like mixture 22.

It is intended that the extruded melt 20 and the flowable color 21 have different material properties, so that they do not mix homogeneously. In other words, inhomogeneous mixing of the extruded melt 20 and the flowable color 21 takes place. The inhomogeneous mixing can be further intensified, for example, if the cooling rollers 41 are rotated at different speeds. As described in the example, the white base color of the extruded melt 20 and the red color of the flowable color 21 mix. The bead-like mixture 22 thus has a randomized multi-coloring consisting of the red and white colors and their mixed colors.

At the cooling rollers 41, the bead-like mixture 22 with the randomized multicoloring cannot only be conveyed, but can also cool and solidify and thus form a film 30 with the randomized multicoloring. The film 30 is illustrated in the figure by the solid black line. Following the cooling rollers 41, the formed film 30 can be conveyed via the conveying roller 42 to the winding roller 43 in the direction of the arrow and wound up on the winding roller 43.

The randomized multicoloring can be seen by the user in particular when the film 30 is viewed from above. The randomized multicoloring represents a security feature for the film 30 and thus increases counterfeit protection.

The randomized multicoloring 50 is shown as an example in FIG. 2. FIG. 2 shows a card-shaped data carrier 32, in particular a smart card, having a card body on which the film 30 with the randomized multicoloring 50 is arranged as a security feature. As an example, the film 30 is provided on the surface of the card body. The card body can comprise any number of other films, which can be laminated to form a film layer composite, for example. Furthermore, the card body has a chip module 31, whereby contact-based data communication can be provided. The chip module 31 is arranged and accommodated in a module opening. Any number of additional electronic components can be provided, for example for contactless data communication.

The randomized multicoloring 50 of the film 30 has multiple randomly distributed colored surface areas. In particular, white colored surface areas, red colored surface areas (which are illustratively shown in black) and mixed colored areas, such as pink areas (which are illustratively shown in grey), may be generated. The colored areas have random sizes and random edge contours. They can merge smoothly into one another at their area boundaries in the perception of a user or the area boundaries are almost sharp. The user of the card-shaped data carrier 32 is presented with a randomly distributed sequence of colored areas. In other words, the user can perceive a multi-colored marbling of the film 30 of the card-shaped data carrier 32. As a result, the card-shaped data carrier 32 has a unique optical security feature that can be optically detected and analyzed.

1. A method for producing a film having a security feature for a card-shaped data carrier, which comprises the following steps:
providing at least one film material having a base color;
providing at least one coloring agent;
introducing the film material into an extruder of an extrusion apparatus;
heating the film material to form a melt;
separately heating the coloring agent to form a flowable color;
extruding the melt through a nozzle outlet gap of the extrusion apparatus;
feeding the flowable color to the extruded melt to form a bead-like mixture;
mixing of the flowable color and the extruded melt within the bead-like mixture to form a film, wherein the extruded melt and the flowable color have different material properties so that they do not mix homogeneously, whereby a randomized multi-coloring is visible in plan view of the film.

2. The method as claimed in claim 1, wherein the method also comprises the following steps:
cooling of the film at a roller arrangement adjacent to the nozzle outlet gap comprising at least one cooling roller.

3. The method as claimed in claim 2, wherein the roller arrangement comprises at least two cooling rollers, wherein the bead-like mixture is conveyed between the cooling rollers.

4. The method as claimed in claim 3, wherein a differential speed of the cooling rollers is set and/or the cooling rollers are operated alternately at different speeds.

5. The method as claimed in claim 1, wherein the film material having a transparent or opaque base color is formed.

6. The method as claimed in claim 1, wherein the flowable color is thermostable and/or has a high viscosity.

7. The method as claimed in claim 1, wherein the flowable color is formed by an offset color or a radiation-crosslinking color, in particular a UV ink.

8. The method as claimed in claim 1, wherein the flowable color is fed to the extruded melt by means of a separate nozzle or by means of a nozzle of the extrusion apparatus.

9. The method as claimed in claim 8, wherein the nozzle is heated.

10. The method as claimed in claim 8, wherein the nozzle has at least one chamber for the flowable color.

11. The method as claimed in claim 10, wherein the nozzle has multiple chambers, especially a multi-chamber system, wherein a different flowable color is provided for each chamber.

12. The method as claimed in claim 11, wherein the chambers are arranged mounted one after the other within the nozzle, whereby the different flowable colors can be fed in strips.

13. The method as claimed in claim 11, wherein the different flowable colors each have different material properties.

14. A film having a security feature for a card-shaped data carrier which is produced by the method as claimed in claim 1.

15. The film as claimed in claim 14, wherein the film has a thickness of 25-100 μm.

16. A card-shaped data carrier, in particular a smart card comprising a card body on which a film having a security feature as claimed in claim 14 is arranged.
